(19) United States
(12) Patent Application Publication
(10) Pub. No.: US 2009/0101665 A1
(43) Pub. Date: Apr. 23, 2009

(54) HYGENIC SOAP AND TOWEL DISPENSING PRODUCT

(76) Inventor: Mike Mulhern, Naperville, IL (US)

Correspondence Address: SABRE TECHNICAL SERVICES CORP., 4917 N. DAMEN AVE., CHICAGO, IL, 60625, US

(21) Appl. No.: 12/255,768

(22) Filed: Oct. 22, 2008

Related U.S. Application Data
(60) Provisional application No. 61/000,088, filed on Oct. 23, 2007.

(51) Int. Cl. B67D 5/56; B67D 5/64; B67D 5/60

(52) U.S. Cl. 221/96; 222/192; 222/129

(57) ABSTRACT

The invention is a soap and towel dispensing product that enables quick and easy restocking of towels and soap and also reduces contact with contaminated surfaces on the product during restocking. The product can hold a soap container beneath a towel enclosure to minimize contamination of the towels by the soap. The product is configured so that the soap container can be removed from the product without requiring a service worker to touch the soap container. The product is configured to that the soap container can be replaced by simply pressing the soap container against the product without rotating the soap container.

This application claims the benefit of the priority date of provisional application 61/000,088, filed Oct. 23, 2007, and incorporates by reference application 61/000,088 in its entirety.

The product is a soap and towel dispensing product that deters spreading bacteria and other contaminants. The product is configured to dispense towels from a towel enclosure and to dispense soap from a soap container positioned beneath the towel enclosure so that soap does not leak into, and otherwise contaminate, the towels and the towel enclosure. The product comprises features that greatly simplify restocking the product with towels and soap. Also, the product comprises features that greatly improve hygienic conditions for the product users, the service workers who perform restocking, and the general locale where the product is located.

The product is especially useful in washrooms and other cleaning stations that experience frequent use by multiple users, for example in restaurants and other retail venues, busy households, sports arenas, transportation centers, and various other locations. Contracted service workers may be utilized to restock the product with towels and soap, so speed and simplicity are important aspects affecting success and profitability of the service.

When restocking the product with soap, the soap container can be released from the product and discarded without touching the soap container, therefore minimizing the transfer of bacteria and other contaminants to other surfaces. Also, a fresh soap container can be mounted to the product by simply pressing the soap container in place without rotating the soap container, making soap container replacement faster and more efficient. The soap container can be released even when the product is stocked with towels and without first removing the towels and without first removing the towel enclosure.

The soap container mounts beneath the towel enclosure via a coupler that releasably connects the soap container to the towel enclosure. The coupler is configured so that simply pressing the soap container against the coupler is sufficient to mount the soap container to the product. This “push-to-connect” feature greatly simplifies and speeds up the process of replacing an empty soap container. In addition, the soap container is released from the product via a coupler actuator where a service worker or other person activates the actuator remotely without requiring direct contact with the soap container. The remote release capability enables release and disposal of the soap container directly to a waste container, thus reducing the likelihood of bacteria and other contaminants being transferred from the soap container to a workers hand and then to other surfaces.

There exist examples in the prior art of towel dispensers and of soap dispensers that are located in high traffic areas that experience frequent use. Often such towel dispensers and soap dispensers are in public areas and are restocked with towels and with soap on a regular, frequent basis by service workers. Each service worker can be responsible for stocking many towel dispensers and soap dispensers and are dependent on speed in restocking to maximize their efficiency. It is useful therefore to have a combined soap and towel dispenser that enables quick and easy restocking of towels and soap in a single dispenser.

In addition, public venues as well as some private venues are lately concerned with the spread of bacteria and other contaminants due to contact with various fixtures within the venue. For example, contact with sink faucets, toilet lids and handles, door handles, towel dispensers and soap dispensers, is considered to be a mode of transferring bacteria from one person to another.

There are examples of soap dispensers and towel dispensers that provide “hands-free” dispensing of soap and towels and thus reduce contact by users with contaminated surfaces and reduce transfer of bacteria from one person to another. However, there has been little effort directed towards reducing contact by service workers with contaminated surfaces during restocking.

There is clearly a need in the market for a soap and towel dispenser that enables quick and easy restocking of towels and soap in a single dispenser and also reduces contact with contaminated surfaces on the dispenser during restocking.

### DRAWINGS

FIG. 1 is a view of an embodiment of the product.

FIG. 2 is an exploded view of the embodiment.

FIG. 3 is an exploded view of a coupler.

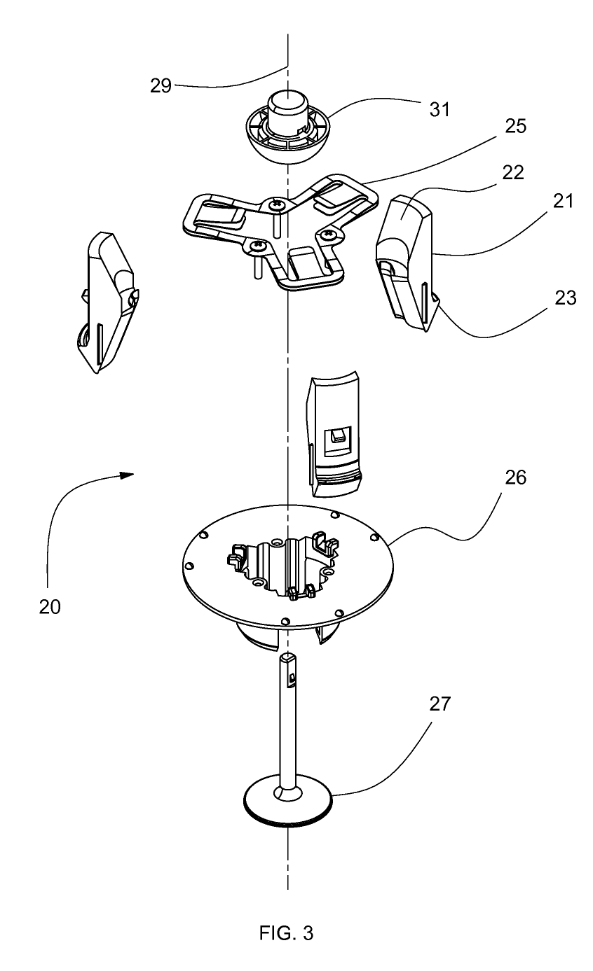

FIG. 4 is an exploded view of a release assembly.

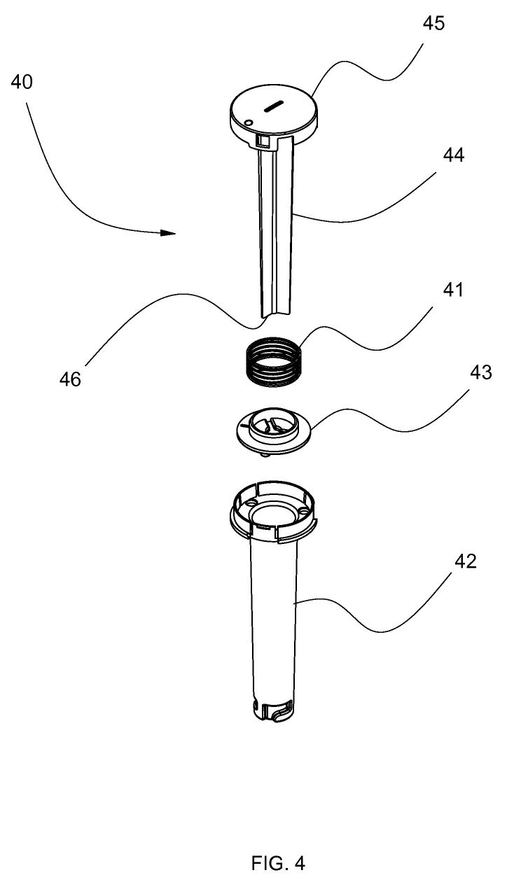

FIG. 5 is a view of a soap container.

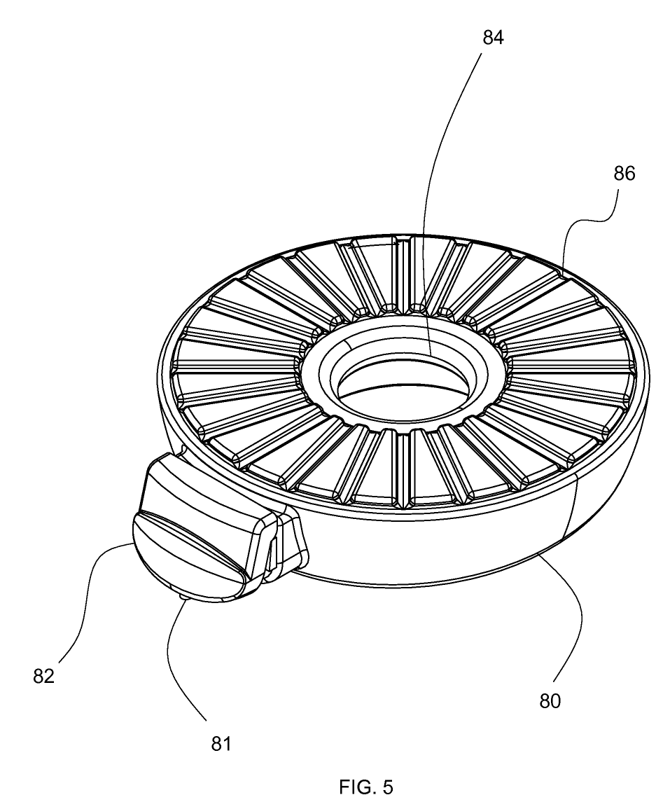

FIG. 6 is a section view of a soap container.

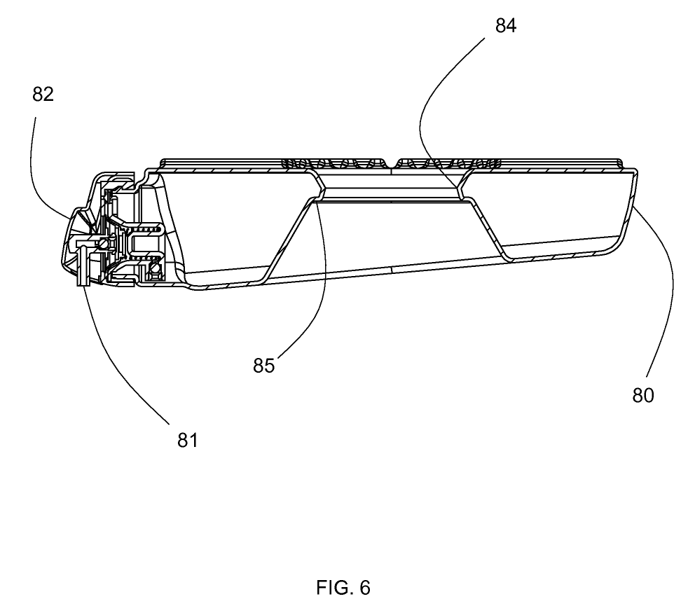

FIG. 7 is a side section view of the embodiment shown in FIG. 1.

FIG. 8 is a detailed section view from within line 8-8.

FIG. 9 is a detailed section view of the embodiment in use.

FIG. 10 is a detailed section view of the embodiment in use.

FIG. 11 is a detailed section view of the embodiment in use.

FIG. 12 is a detailed section view of the embodiment in use.

FIG. 13 is a detailed section view of the embodiment in use.

FIG. 14 is a view of another embodiment of the product.

FIG. 15 is an exploded view of the embodiment shown in FIG. 14.

FIG. 16 is a view of a coupler from the embodiment shown in FIG. 14.

FIG. 17 is a side section view of the embodiment shown in FIG. 14.

FIG. 18 is a detailed section view from within line 18-18.

FIG. 19 is a detailed section view of the embodiment in use.

FIG. 20 is a detailed section view of the embodiment in use.

### SUMMARY OF THE INVENTION

The invention is a soap and towel dispensing product that enables quick and easy restocking of towels and soap and also reduces contact with contaminated surfaces on the product during restocking.

In one embodiment, the product has a towel enclosure for dispensing towels from a towel roll within the towel enclosure through an opening in the towel enclosure. The product also has a coupler mounted to the towel enclosure, and the coupler releasably connects a soap container to the product such that the soap container is mounted beneath the towel enclosure. The product has a coupler actuator, the coupler actuator when activated causing the coupler to release the soap container. The coupler actuator can be activated at a distance from the soap container and without contacting the soap container. The coupler can be configured such that the soap container separates from the product and falls away from the product when the coupler releases the soap container.

In second embodiment, the product can have a towel enclosure for dispensing towels from a towel roll within the towel enclosure via an opening in the towel enclosure. The product can have a soap container having a coupling component. The product can have a coupler mounted to the towel enclosure, where the coupler can have a coupled state and an uncoupled state. The coupler in the coupled state can engage the coupling component to hold the soap container beneath the towel enclosure. The coupler in the uncoupled state can release the soap container. The product can have a coupler actuator and the coupler actuator, when activated, can cause the coupler to change to the uncoupled state and to discharge the soap container from the product. The coupler actuator can be activated at a distance from the soap container and without directly contacting the soap container. Pressing the coupling component against the coupler without rotating the coupling component can be wholly sufficient to cause the coupler to change to the coupled state and engage the coupling component to hold the soap container beneath the towel enclosure.

In a further embodiment, the product can have a coupler having a coupled state and an uncoupled state. The product can have a soap container having a coupling component. The coupler in the coupled state can engage the coupling component to hold the soap container beneath the coupler. The coupler can change to the coupled state and engage the coupling component when the coupling component is pressed against the coupler without rotating the coupling component. The product can have a coupler actuator and the coupler actuator, when activated, can cause the coupler to change to the uncoupled state and to discharge the soap container from the dispenser. The coupler actuator can be activated at a distance from the soap container and without directly contacting the soap container. The product can have a towel enclosure that can be removably mounted above the coupler. The towel enclosure can dispense towels from a towel roll within the towel enclosure via an opening in the towel enclosure. The towel enclosure can have a release implement having an operator end and a coupler end, where the operator end can protrude out of the towel enclosure. The coupler end can extend through the towel enclosure to operatively engage the coupler actuator so that operating the release implement from outside the towel enclosure activates the coupler actuator.

### DETAILED DESCRIPTION OF THE INVENTION

The product can dispense both towels and soap and can be used in public washrooms, restaurant cleanup areas, and in various public and private venues where it is necessary and convenient to have washing facilities.

The product can comprise a towel enclosure. The towel enclosure can cover and protect the towels from contamination prior to dispensing. The towel enclosure can dispense towels through an opening in the towel enclosure. The towel enclosure can be removable so that towels can be restocked. The towel enclosure can comprise more than one towel enclosure component.

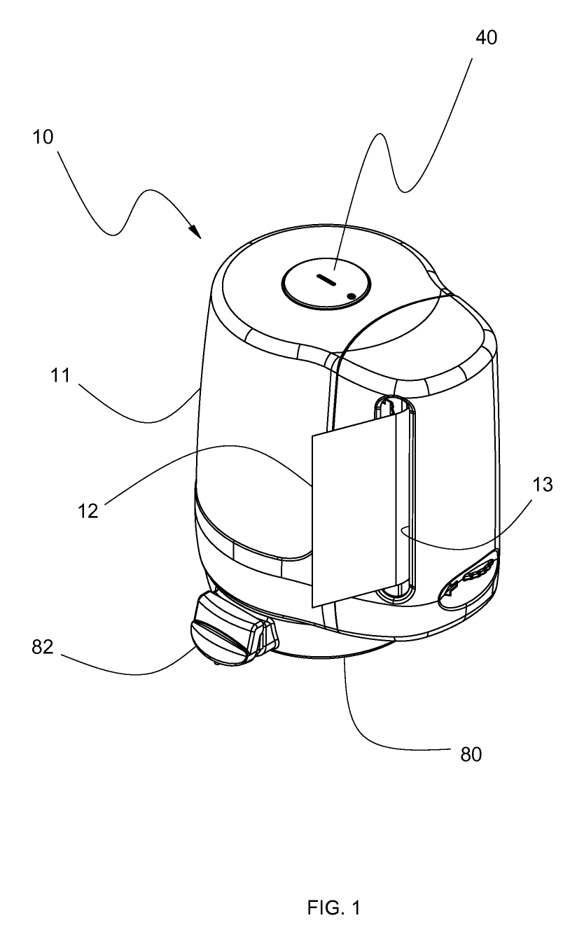

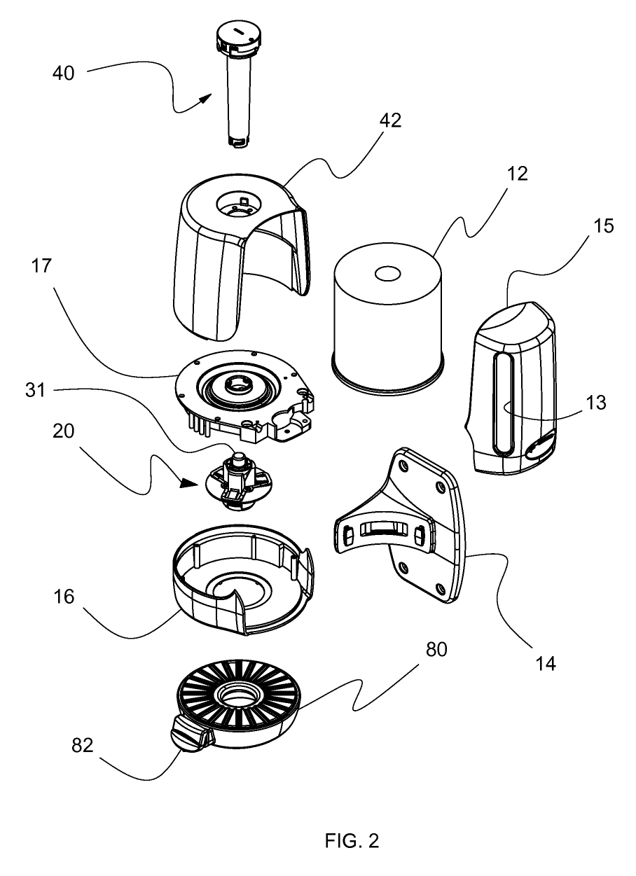

As shown in FIG. 1 and FIG. 2, the product 10 comprises a towel enclosure 11 and an opening 13 for dispensing towels from within the towel enclosure 11. The towel enclosure 11 can comprise a side panel 15.

The towel enclosure can comprise an automated advance component for automatically extending towels through the opening after dispensing. The automated advance component is useful for ensuring the towels extend beyond the opening prior to dispensing.

For example, the automated advance component can comprise a motor-driven towel support. The motor-driven support can automatically extend towels after towels are dispensed. As the towels extend they protrude beyond the opening so that the towels are accessible to a user.

Various automated advance components are known and used in the art of towel dispensing. The automated advance component can be a known advance component and can be a novel advance component. The advance component can be a combination of known and novel advance components.

The automated advance component can be detector-activated and extend towels when a detector detects an appropriate signal. For example, the advance component can extend towels when a motion detector detects a motion signal. Alternatively, the advance component can extend towels when a light detector detects a light signal and detects a no-light signal. Alternatively, the advance component can extend towels when a sound detector detects a sound signal. The advance component can be detector-activated by various detectors and combinations thereof.

The advance component can be battery-powered and can be powered by line voltage via a wired connection. The advance component can be mechanically powered via a spring and mechanically powered by various mechanical means, electrical means, and combinations thereof.

The towel enclosure 11 can hold a towel roll 12. Alternatively, the towel enclosure can hold folded towels and various types of towels so long as the towels are dispensable from within the towel enclosure.

The towel enclosure 11 can be transparent, can be translucent, and can be opaque.

As shown in FIG. 2, the product 10 can comprise a platform 17. The towel enclosure 11 can be removably connected to the platform 17 and the towel roll 12 can be supported by the platform 17.

Alternatively, the towel roll 12 can be supported by a support element medial the platform 17 and the towel roll 12. Alternatively, the towel roll 12 can be supported by the towel enclosure 11 and by various other product components so long as the towel roll 12 is positioned within the towel enclosure 12.

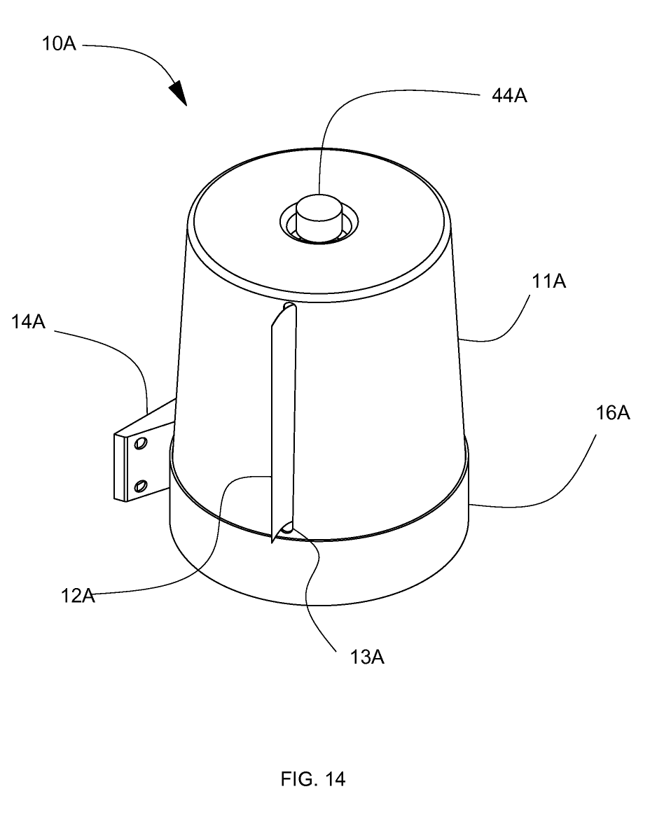

In FIG. 14, the product 10A has a towel enclosure 11A including an opening 13A for dispensing towels. The product 10A has a platform 17A for supporting towels.

The product can comprise a coupler that releasably connects to a soap container. The coupler can be mounted to the towel enclosure and connect to the soap container so that the soap container is held beneath the towel enclosure. Holding the soap container beneath the towel enclosure minimizes soap and other contaminants from the soap container entering the towel enclosure. The coupler is configured so that the soap container completely separates from the product and falls away from the product when the coupler releases the soap container.

The coupler can be configured to connect to a coupling component on the soap container. The coupling component can be a specific feature of the soap container and can be a combination of features of the soap container. The coupling component can be inherent in the shape of the soap container.

The coupler is further configured so that pressing the soap container against the coupler, without rotating the soap container, causes the coupler to connect to the soap container and hold the soap container beneath the towel enclosure. The push-to-connect interaction between the coupler and the soap container simplifies and speeds up replacing the soap container. Since the soap can be consumed when the product is used, the soap container may need to be replaced regularly, and the product minimizes the amount of time a service worker expends in replacing the soap container.

The product can comprise a coupler actuator. Activating the coupler actuator can cause the coupler to release the soap container. The coupler actuator is activated at a distance from the soap container and the coupler actuator does not directly contact the soap container. Activating the actuator from a distance and without contacting the soap container minimizes soap and other contaminants being transmitted to a service workers hands and to various surfaces during soap container removal.

A service worker can remove the soap container by placing a waste container underneath the product and activating the coupler actuator to cause the coupler to release the soap container and allow the soap container to fall away from the product into the waste container. Throughout the abovementioned removal, the service worker never has to directly contact the soap container.

The product 10 can comprise a coupler 20. The coupler 20 releasably connects a soap container 80 to the product 10 and holds the soap container 80 beneath the towel enclosure 11. The coupler 20 can be mounted to the towel enclosure 11 and can be mounted to various other product elements so long as the coupler 20 can hold the soap container 80 beneath the towel enclosure 11.

The coupler 20 can release the soap container 80 and allow the soap container 80 to separate from the coupler 10 and fall away from the product 10.

The coupler can connect to and release the soap container in various ways and utilizing various components and features.

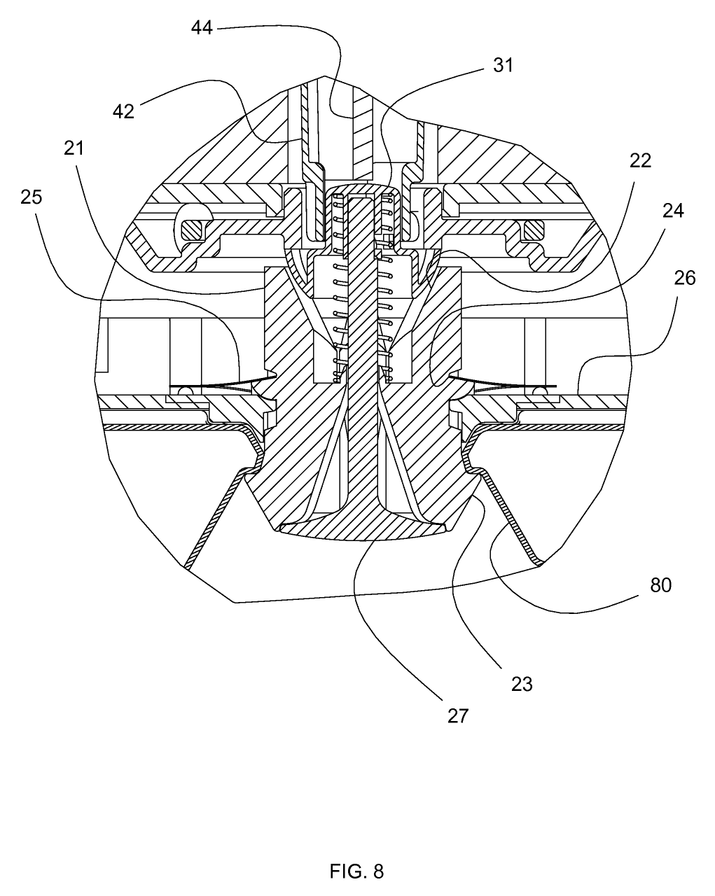

As shown in FIG. 8, the coupler 20 can connect to the soap container 80 via one or more pivoting latches, such as the pivoting latch 21. The pivoting latch 21 can have an actuator end 22 and a container end 23. The pivoting latch 21 can pivot about a pivot point 24 medial the actuator end 22 and the container end 23.

The coupler 20 can have a coupled state and an uncoupled state. The coupler 20 in the coupled state can connect to the soap container 80 via the container end 23. As shown in FIG. 8, the pivoting latch 21 pivots about the pivot point 24 so that the container end 23 moves outwards to engage the soap container 80.

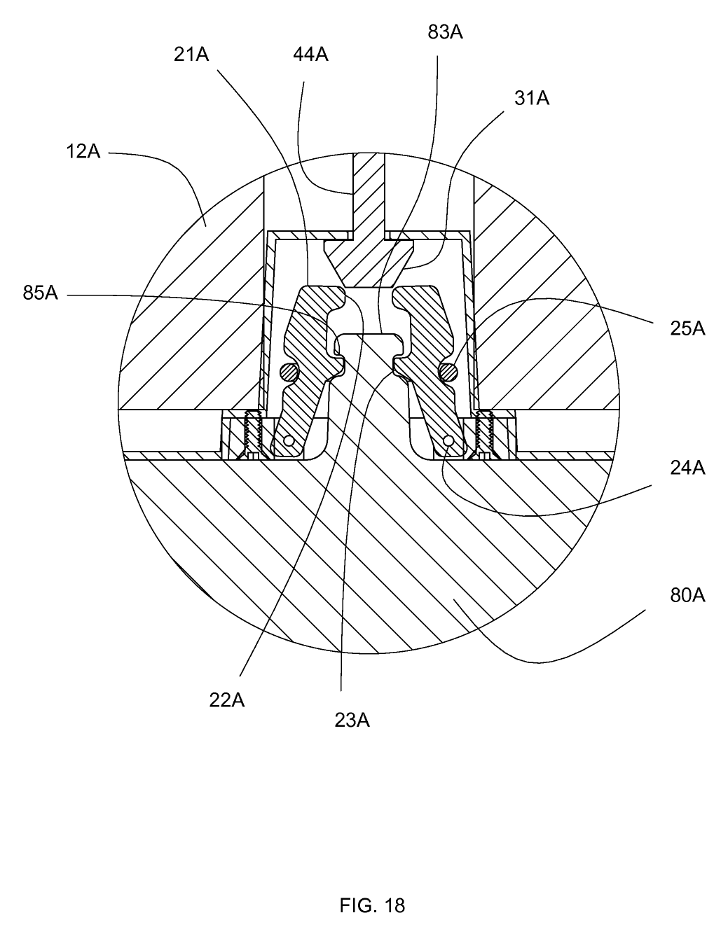

Alternatively, the pivoting latch can pivot about a different pivot point, for example a pivot point distal both the actuator end and the container end. As shown in FIG. 18, a coupler 20A can connect to a soap container 80A via one or more pivoting latches, such as a pivoting latch 21A. The pivoting latch 21A can have an actuator end 22A and a connector end 23A. The pivoting latch 21A can pivot about a pivot point 24A distal the actuator end 22A and the container end 23A.

The coupler 20A can have a coupled state and an uncoupled state. The coupler 20A in the coupled state can connect to the soap container 80A via the container end 23A. As shown in FIG. 18, the pivoting latch 21A pivots about the pivot point 24A so that the container end 23A moves inwards to engage the soap container 80A.

The coupler can have a bias member for biasing the pivoting latch towards the coupled position and towards the uncoupled position. The coupler 20 has a flat spring 25 that biases the pivoting latch 21 towards the coupled position. Similarly, the coupler 20A has an elastic band 25A that biases the pivoting latch 21A towards the coupled position.

The product can comprise a coupler actuator, such as a coupler actuator 31. The towel enclosure 11 can be removed from the product to expose the coupler actuator. The coupler actuator 31 can be activated to cause the coupler 20 to release the soap container 80 by pressing the coupler actuator 31 towards the pivoting latch 21. The coupler actuator 31 can contact the pivoting latch 21 at the actuator end 22 and causes container end 23 to move inwards and disengage from the soap container 80.

The coupler actuator 31 when activated does not contact the soap container and therefore minimizes soap and other contaminants being transmitted to a service workers hands and to various surfaces when activating the coupler actuator.

A coupler actuator 31A, as shown in FIG. 18, functions similarly to the coupler actuator 31, except that the coupler actuator 31A causes the container end 23A of the pivoting latch 21A to move outwards and disengage from the soap container 80A.

The product can comprise various types of coupler actuators that interact with various couplers, so long as the coupler actuator can cause the coupler to release the soap cartridge and so long as the coupler actuator when activated does not contact the soap container.

The product can comprise a release implement. The release implement can be employed to activate the coupler actuator from outside the towel enclosure. The release implement can extend from proximal the coupler through the towel enclosure, and can protrude from the towel enclosure.

The release implement is useful for activating the coupler actuator when the towel enclosure is connected to the coupler and when towels are present in the towel enclosure. The release implement further facilitates fast and efficient removal and replacement of the soap container by enabling a service worker or other person to remove and replace the soap container without removing the towel enclosure.

The product 10 has a release assembly 40 including a release implement 44. The release implement 44 has an operator end 45 and a coupler end 46. The release implement 44 can pass through a cover 42 from above the towel enclosure 11 so that the operator end 45 can protrude out of the towel enclosure 11. The release implement 44 can extend downwards through the cover 42 to operatively engage the coupler actuator 31 with the coupler end 46 so that pressing down the release implement activates the coupler actuator 31 and causes the coupler 20 to release the soap container 80.

The product 10 further comprises a release spring 41 for biasing the release implement in an upward position. The release spring 41 rests upon a spring base 43 contained within the cover 42.

The cover 42 can be releasably connected to the product 10 and when connected can retain the towel enclosure in place on the product.

The product 10A has a release implement 44A. The release implement 44A can pass through the towel enclosure 11A from above the towel enclosure 11A. The release implement 44A can extend downwards through the towel enclosure to contact the coupler actuator 31A so that pressing down the release implement 44A activates the coupler actuator 31A and causes the coupler 20A to release the soap container 80A. The product 10A has a release spring 41A to bias the release implement 44A in an upward position.

The product can comprise a lock for preventing unauthorized operation of the coupler. The product 10 has a lock 27. The lock 27 can seat against the pivoting latch 21 and prevent the pivoting latch 21 from pivoting inwards to release the soap container. The lock 27 is configured so that activating the coupler actuator 31 causes the lock 27 to unseat from against the pivoting latch 21, therefore enabling the coupler actuator 31 to pivot the pivoting latch 21 and disengage from the soap container 80.

The lock 27 comprises a stem 271 and a flange 272. The flange 272 is positioned proximal the pivoting latch container end 23 and, when in use, can contact a container end shoulder 28. With the lock 27 in place against the pivoting latch 21, the pivoting latch 21 cannot be manipulated to disengage from the soap container by reaching up from below the soap container.

When the coupler actuator 31 is pressed towards the actuator end 22 of the pivoting latch 21, the coupler actuator 31 first contacts the stem 271 and moves the lock 27 downwards so that the lock 27 unseats from against the pivoting latch 21.

The product can comprise various locks that cooperate with various couplers so long as the lock can prevent unauthorized operation of the coupler.

The product 10 can comprise a lower housing 16 and a wall mount 14. The lower housing can house the coupler and can provide tamper-resistance. The wall mount can be utilized to mount the product 10 to a surface so as to enable easy access to the product 10.

The product 10A can comprise a lower housing 16A and a wall mount 14A.

The product can comprise a soap container. For example, the product 10 has a soap container 80. The soap container 80 can have a coupling component, for example a mounting hole. The soap container 80 is substantially toroidally shaped with the mounting hole extending through the soap container 80. The mounting hole has a mounting hole periphery 84 with a shoulder 85. The coupler 20 can engage the mounting hole periphery 84 to hold the soap container 80 beneath the towel enclosure 11. As shown in FIG. 8, in the coupled state the pivoting latch 21 can engage the mounting hole periphery 84 via the container end 23 contacting the shoulder 85.

The soap container can have various shapes other than toroidal. The mounting hole can be wholly bounded by the container and can be only partially bounded, i.e. can be U shaped, C-shaped, and other open shapes, so long as the soap container has a mounting hole periphery that can be engaged by the coupler.

The soap container can be curvilinear. Alternatively, the soap container can be formed of straight surfaces and angles, and can be a combination of curvilinear and straight surfaces.

The soap container can be sized to fit beneath the towel enclosure. The soap container 80 is approximately 9.5 inches in diameter across the top and approximately 2.5 inches deep. Soap containers can have various sizes and shapes.

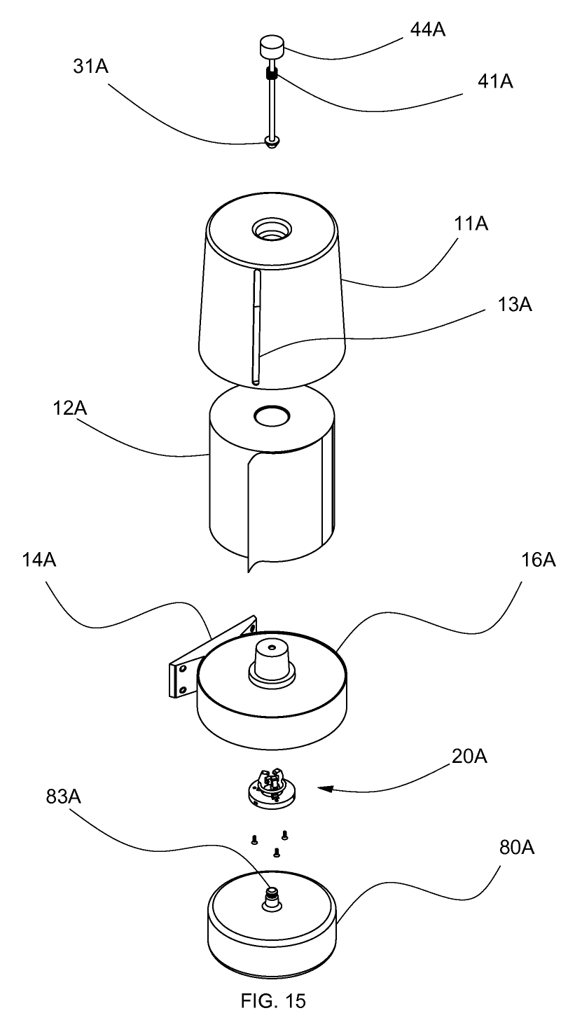

As shown in FIG. 15, the product 10A has a soap container 81A. The soap container 81A has a coupling component, for example the mounting staff 83A. The soap container 81A is substantially cylindrical with the mounting staff 83A extending outwards from a top surface.

The mounting staff 83A has a groove 85A that can be engaged by the coupler 20A to hold the soap container 80A beneath the towel enclosure 11A. In the coupled state, the pivoting latch 21A can engage the mounting staff 83A via the container end 23A contacting the groove 85A.

The soap container can dispense soap directly to a user and can transfer soap out of the soap container for separate dispensing.

The soap container 80 can dispense soap directly to a user via a dispenser nozzle 81. The soap container 80 has a regulator 82 for causing soap to dispense from the soap container 80 through the nozzle 81. The regulator 82 is a pushbutton that forces soap through the nozzle 81.

Alternatively, the regulator can be a valve that allows soap to flow through the nozzle. Alternatively, the regulator can create soap foam that is dispensed from the nozzle. The regulator can be various types and combinations thereof, so long as the regulator can cause soap to dispense from the nozzle.

The soap container 80A has a regulator 82A for causing soap to dispense from the nozzle 81A. The regulator 82A is a valve that can be raised to allow soap to flow through the nozzle 81A.

The soap container can comprise an automated soap dispensing system. The soap dispensing system can be detector-activated and dispense soap when a detector detects an appropriate signal. For example, the soap dispensing system can dispense soap when a motion detector detects a motion signal. Alternatively, the soap dispensing system can dispense soap when a light detector detects a light signal and detects a no-light signal. Alternatively, soap dispensing system can dispense soap when a sound detector detects a sound signal. The soap dispensing system can be detector-activated by various detectors and combinations thereof.

The soap dispensing system can be battery-powered and can be powered by line voltage via a wired connection. The soap dispensing system can be mechanically powered via a spring and mechanically powered by various mechanical means, electrical means, and combinations thereof.

The soap container can be rotatably positioned and held with respect to the coupler. For example, the soap container 80 can be rotated about a coupler axis 29 so that the nozzle is accessible to a user. The soap container 80 can have an indexing stop, for example the indexing stop 86. The indexing stop 86 can cooperatively engage with the product to enable incrementally adjustable rotational positioning.

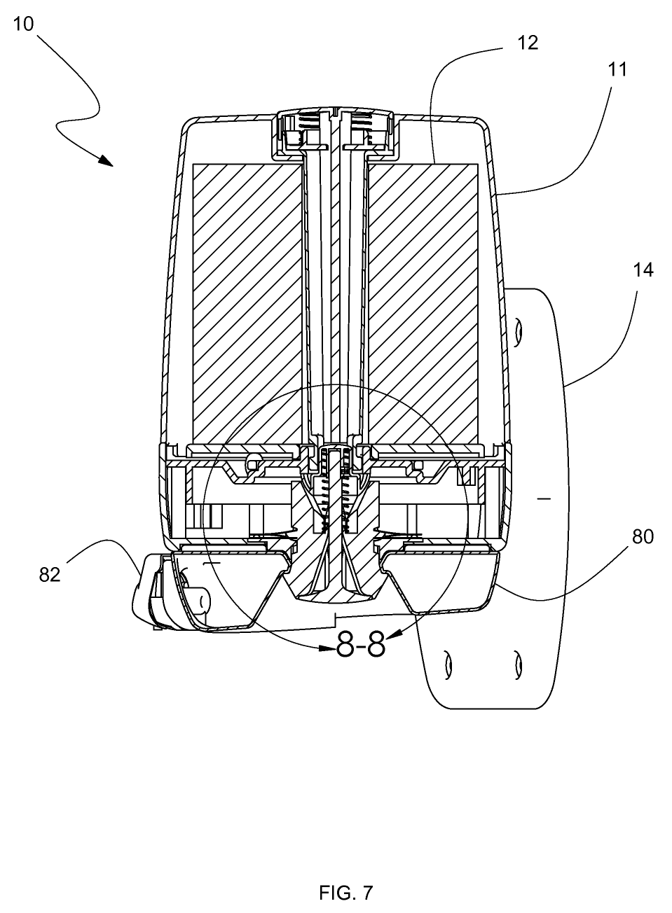

FIGS. 7 through 13 illustrate an embodiment of the product as the coupler releases the soap container and illustrate an embodiment of the product as the soap container is pressed against the coupler to cause the coupler to engage the soap container.

FIG. 7 is a section view of the product 10.

FIG. 8 is a detail view within the line 8-8 that shows the coupler 20 holding the soap container 80 beneath the towel enclosure 11. The soap container 80 is held against the frame 26. The pivoting latch 21 is pivoted about the pivot point 24 and the container end 23 has engaged the soap container 80.

The coupler actuator 31 is positioned above the actuator end 22 and the release implement 44 is positioned above the coupler actuator 31. An actuator spring 32 can act between the coupler actuator 31 and the pivoting latch 21 so that the pivoting latch 21 is biased towards engaging the soap container.

The lock 27 is in place against the pivoting latch 21 with the flange 272 contacting the container end shoulder 28 so that the pivoting latch 21 cannot be manipulated from below the soap container 80.

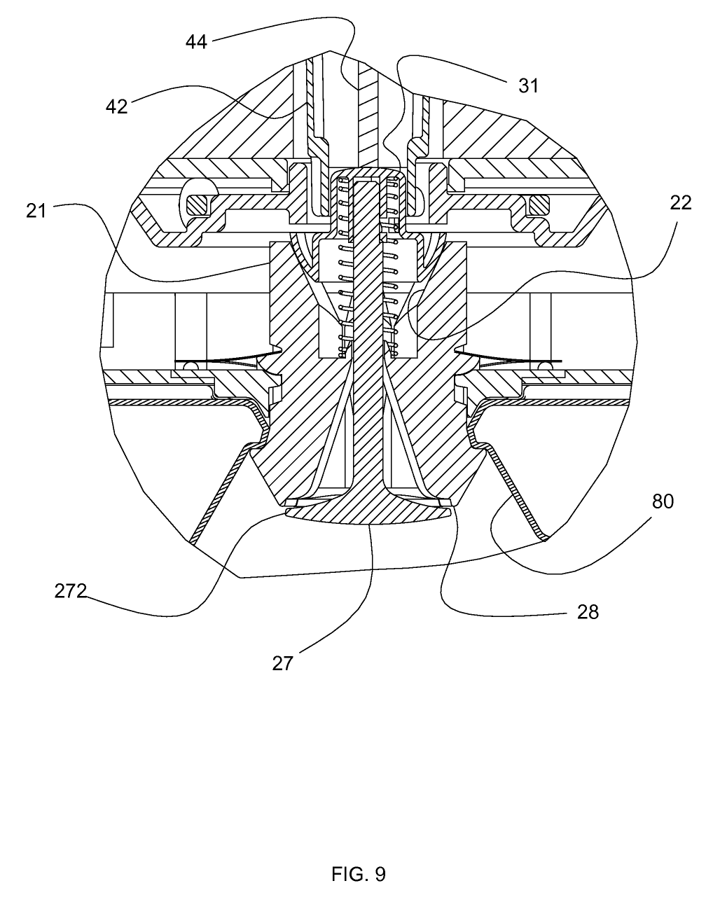

In FIG. 9, the release implement 44 has moved downwards and caused the coupler actuator 31 to contact the actuator end 22. Also, the coupler actuator 31 has contacted the stem 271 and caused the lock 27 to disengage from the pivoting latch 21, freeing the pivoting latch 21 to pivot towards releasing the soap container 80. While the coupler actuator 31 can be activated at a distance from the soap container 80 by the release implement 44, the coupler actuator 31 could be similarly activated at a distance from the soap container 80 by pressing the coupler actuator 31 itself, with the towel enclosure 11 and the release implement 44 removed from the product 10.

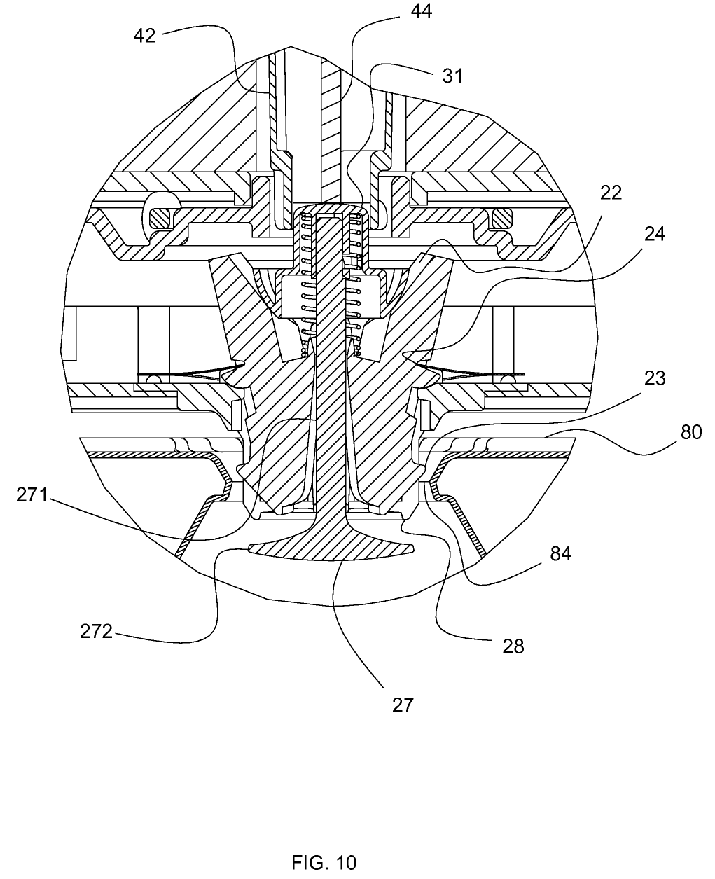

In FIG. 10, the release implement 44 has moved further downwards and caused the coupler actuator 31 to fully release the soap container 80. The soap container 80 is wholly separated from the coupler 20 and can fall away from the product 10.

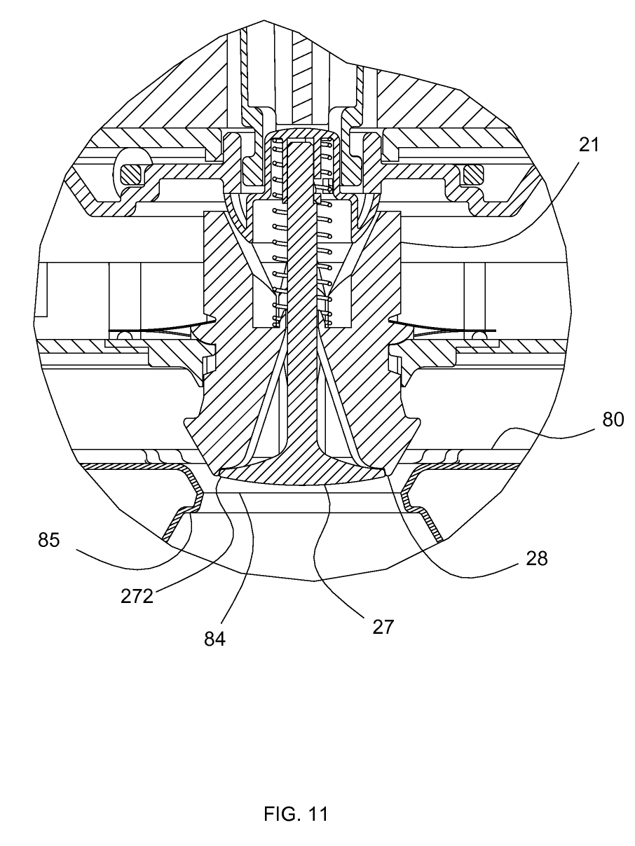

FIG. 11 shows the product 10 with the soap container 80 separated from the product 10 and in position to press against the coupler 20 and to cause the coupler 20 to connect to the soap container 80. The pivoting latch 21 has the container end 23 pivoted outwards and the lock 27 is positioned with the flange 272 contacting the container end shoulder 28.

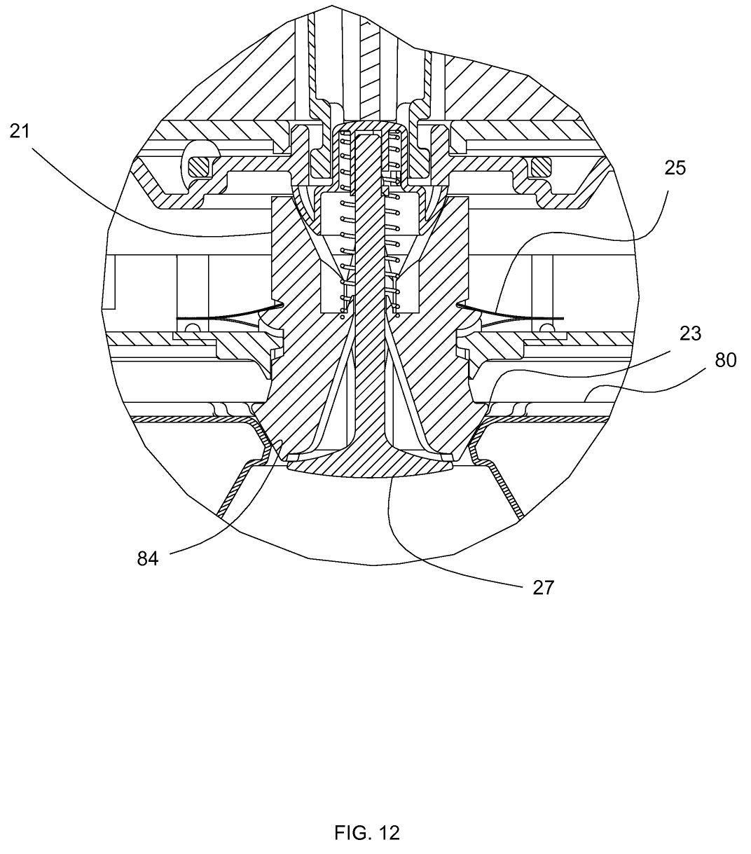

FIG. 12 shows the soap container 80 pressed upwards against the coupler 20. The mounting hole periphery 84 is contacting the container end 23. As the soap container 80 is pressed upwards, the flat spring 25 deflects to enable the pivoting latch 21 to move upwards and separate from the lock 27. Once separated from the lock 27, the pivoting latch 21 can pivot so that mounting hole periphery 84 can move past the container end 23.

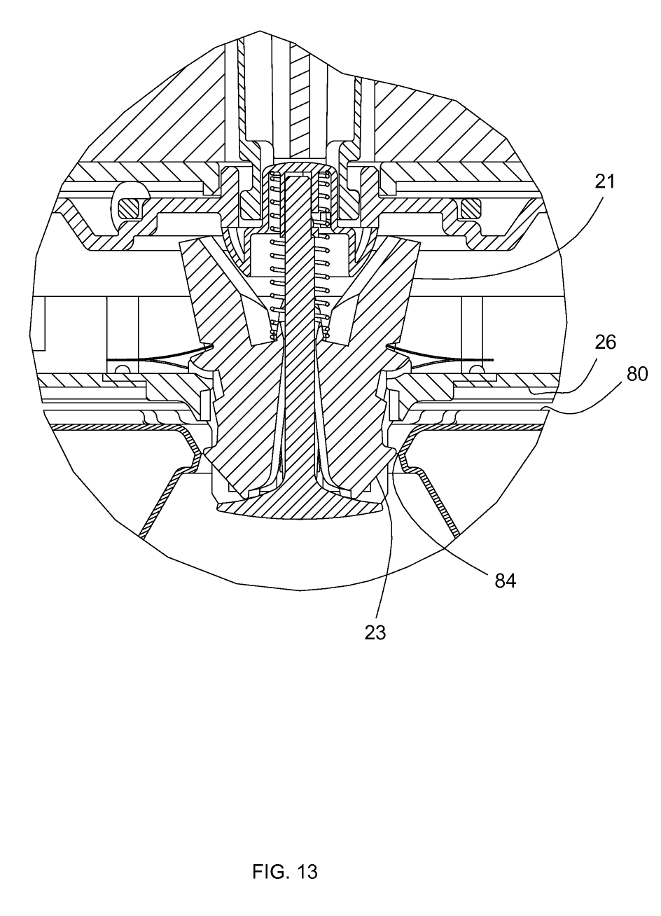

FIG. 13 shows the pivoting latch 21 pivoted to within the mounting hole periphery 84 and the soap container 80 positioned to connect to the coupler 20. When the soap container 80 moves further upwards and contacts the frame 26, the product 10 will return to the position shown in FIG. 8 and the coupler 20 will hold the soap container 80 beneath the towel enclosure 11.

FIG. 14 shows the product 10A. As further illustrated in FIG. 15, the product 10 A has the towel enclosure 11A and dispenses towels 12A through the opening 13A. The product 10A has the release implement 44A and the coupler actuator 31A. The product 10A has a wall mount 14A and a lower housing 16A.

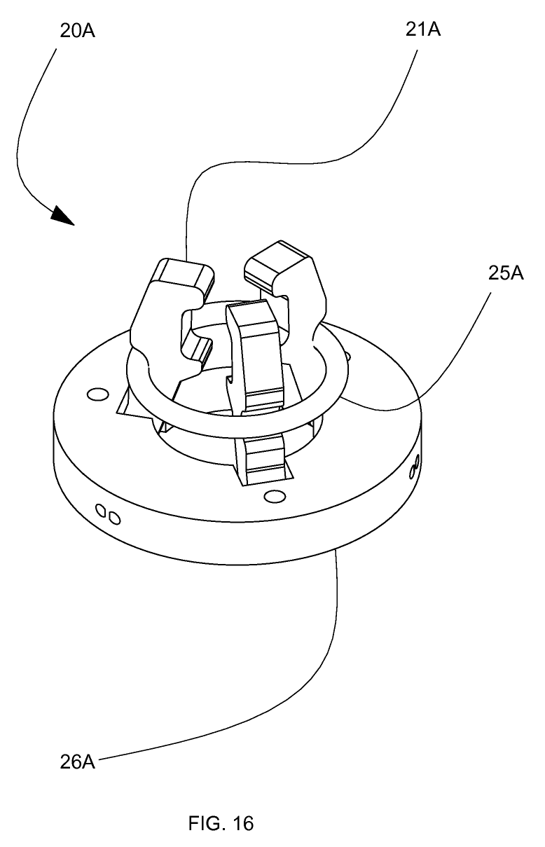

The product 10A has the coupler 20A that mounts beneath the towel enclosure 11A. As shown in FIG. 16, the coupler 20A comprises the pivoting latch 21A pivotally mounted to a frame 26A. The coupler 20A has a bias element, for example the elastic band 25A that biases the pivoting latch 21A towards a coupled state.

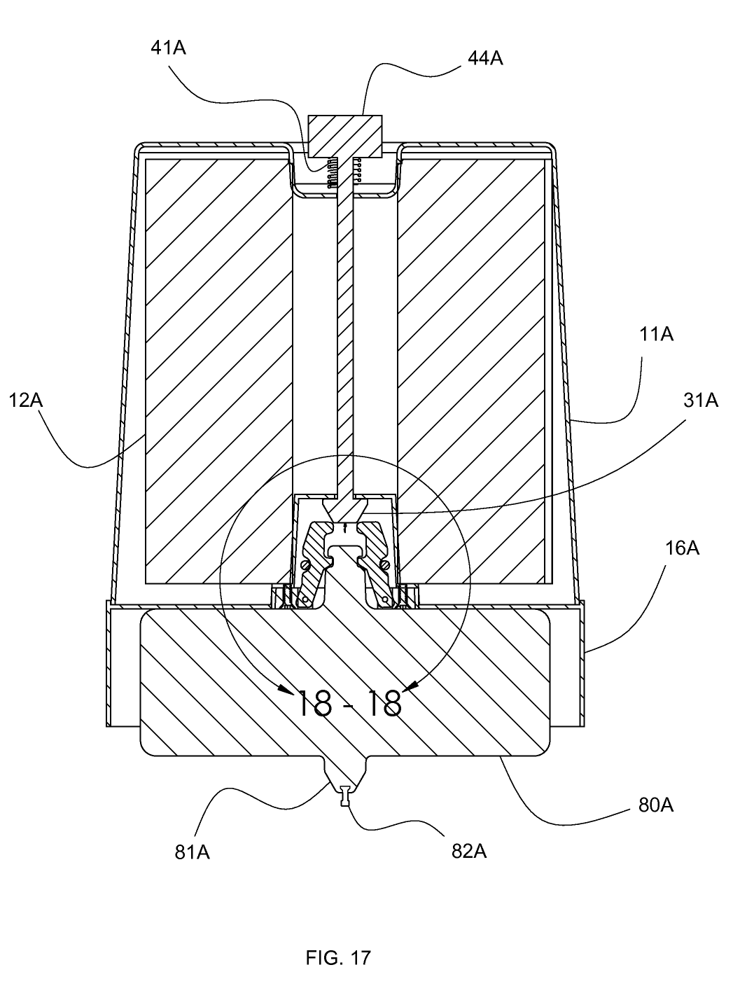

FIG. 17 is a section view of product 10A and shows the product 10A with the soap container 80A connected to the coupler 20A and held beneath the towel enclosure 11A.

FIG. 18 is a detail section view from within line 18-18. The pivoting latch 21A has the actuator end 22A and the container end 23A. The coupler 20A connects to the soap container 80A via the mounting staff 83A. In the coupled state the container end 23A is seated in a groove 85A causing the coupler 20A to hold the soap container 80A beneath the towel enclosure 11A.

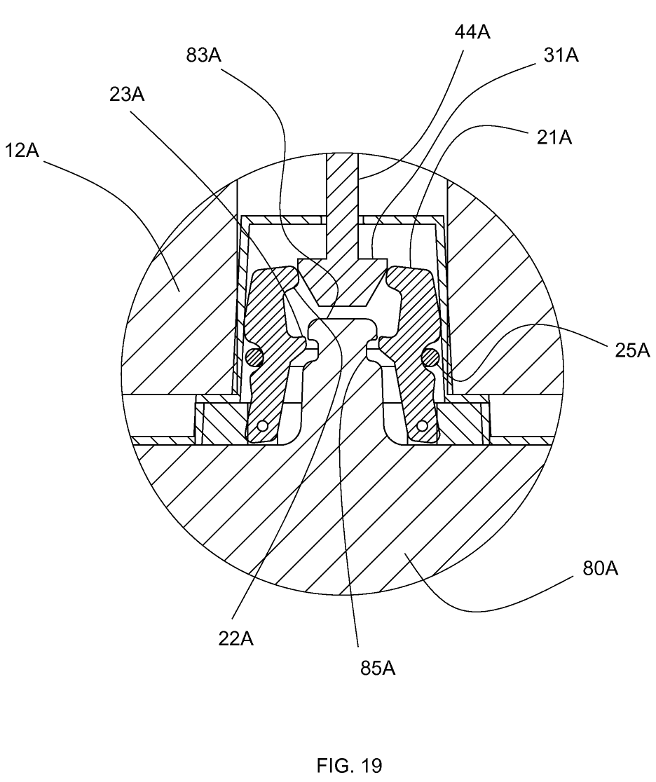

FIG. 19 shows the product 10A as the release implement 44A activates the coupler actuator 31A. The coupler actuator 31A has moved to contact the actuator end 22A and to cause the pivoting latch 21A to pivot so that the container end 23A disengages from the groove 85A, releasing the soap container 80A from the coupler 20A.

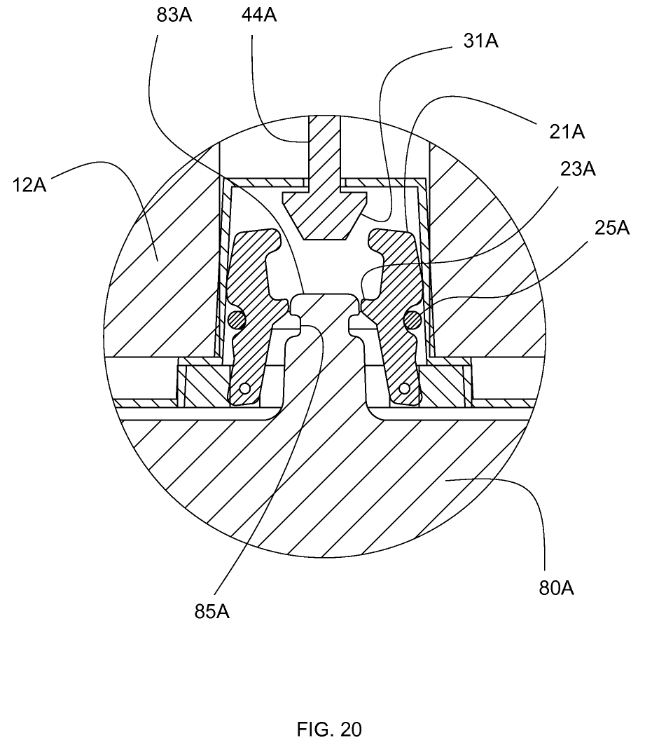

FIG. 20 shows the product 10A as the soap container 80A is pressed against the coupler 20A, causing the pivoting latch 21A to pivot away from the mounting staff 83A until the container end 23A can engage the groove 85A.

Claimed is:

1. A soap and towel dispenser product comprising:
a towel enclosure, the towel enclosure dispensing towels from a towel roll within the towel enclosure through an opening in the towel enclosure;
a coupler mounted to the towel enclosure;
the coupler releasably connecting a soap container to the product such that the soap container is mounted beneath the towel enclosure;
a coupler actuator, the coupler actuator when activated causing the coupler to release the soap container;
the coupler actuator being activated at a distance from the soap container and without contacting the soap container; and
the coupler being configured such that the soap container separates from the product and falls away from the product when the coupler releases the soap container.

2. The soap and towel dispenser product of claim 1 wherein the coupler comprises:
at least one pivoting latch;
the pivoting latch having an actuator end and a container end;
the container end in use releasably connecting to the soap container;
and wherein the coupler actuator contacts the actuator end and pivots the pivoting latch to release the soap container.

3. The soap and towel dispenser product of claim 1 wherein the coupler comprises:
at least one pivoting latch;
the pivoting latch having an actuator end and a container end;
the pivoting latch pivoting about a point medial the actuator end and the container end;
the container end in use releasably connecting to the soap container;
and wherein the coupler actuator contacts the actuator end and pivots the pivoting latch to release the soap container.

4. The soap and towel dispenser product of claim 1 further comprising:
a release implement, the release implement extending from proximal the coupler through the towel enclosure and protruding from the towel enclosure;
the release implement, when employed from outside the towel enclosure, activating the coupler actuator to cause the coupler to release the soap container.

5. A soap and towel dispenser product comprising:
a towel enclosure dispensing towels from a towel roll within the towel enclosure via an opening in the towel enclosure;
a soap container having a coupling component;
a coupler mounted to the towel enclosure;
the coupler having a coupled state and an uncoupled state;
the coupler in the coupled state engaging the coupling component to hold the soap container beneath the towel enclosure;
the coupler in the uncoupled state releasing the soap container;
a coupler actuator, the actuator when activated causing the coupler to change to the uncoupled state and discharging the soap container from the product;
the coupler actuator being activated at a distance from the soap container and without directly contacting the soap container; and
wherein pressing the coupling component against the coupler without rotating the coupling component is wholly sufficient to cause the coupler to change to the coupled state and engage the coupling component to hold the soap container beneath the towel enclosure.

6. The soap and towel dispenser of claim 5 further comprising:
a release implement, the implement extending from proximal the coupler through the towel enclosure and protruding from the towel enclosure;
the release implement, when employed from outside the towel enclosure, activating the coupler actuator to cause the coupler change to the uncoupled state.

7. The product of claim 5 where the coupling component comprises:
a central hole through the soap container, the central hole having a central hole periphery; and wherein
the coupler in the coupled state engages the central hole periphery.

8. The product of claim 5 wherein the coupling component comprises:
a protrusion; and wherein
the coupler in the coupled state engages the protrusion.

9. The dispenser of claim 5 wherein the coupler comprises:
at least one pivoting latch;
the pivoting latch having an actuator end and a container end;
and wherein the coupler in the coupled state engages the coupling component via the container end of the pivoting latch;
and wherein the coupler actuator when activated contacts the actuator end of the pivoting latch and causes the coupler to change to the uncoupled state.

10. A soap and towel dispenser product comprising:
a coupler having a coupled state and an uncoupled state;
a soap container having a coupling component;
the coupler in the coupled state engaging the coupling component to hold the soap container beneath the coupler;
the coupler changing to the coupled state and engaging the coupling component when the coupling component is pressed against the coupler without rotating the coupling component;
a coupler actuator, the coupler actuator when activated causing the coupler to change to the uncoupled state and to discharge the soap container from the dispenser;
the coupler actuator being activated at a distance from the soap container and without directly contacting the soap container;
a towel enclosure being removably mounted above the coupler;
the towel enclosure dispensing towels from a towel roll within the towel enclosure via an opening in the towel enclosure;
the towel enclosure comprising a release implement having an operator end and an coupler end;
the operator end protruding out of the towel enclosure; and
the coupler end extending through the towel enclosure to operatively engage the coupler actuator so that operating the release implement from outside the towel enclosure activates the coupler actuator.

11. The product of claim 10 where the coupling component comprises:
a central hole through the soap container, the central hole having a central hole periphery; and wherein
the coupler in the coupled state engages the central hole periphery.

12. The product of claim 10 wherein the coupling component comprises:
a protrusion; and wherein
the coupler in the coupled state engages the protrusion.

13. The product of claim 10 wherein the coupler comprises:
at least one pivoting latch;
the pivoting latch having an actuator end and a container end;
and wherein the coupler in the coupled state engages the coupling component via the container end of the pivoting latch;
and wherein the coupler actuator when activated contacts the actuator end of the pivoting latch and causes the coupler to change to the uncoupled state.

14. The product of claim 10 wherein the coupler comprises:
a first pivoting latch and a second pivoting latch;
each pivoting latch having an actuator end and a container end with the actuator end being proximal the towel enclosure;
the first pivoting latch and the second pivoting latch being spaced apart about a latch axis;
the first pivoting latch and the second pivoting latch being biased towards the coupled state;
the first pivoting latch and the second pivoting latch in the coupled state engaging the coupling component with the container end to hold the soap container beneath the coupler; and wherein
the coupling actuator when activated contacts the first pivoting latch and the second pivoting latch at the actuator end and causes the coupler to change to the uncoupled state.

15. The product of claim 10 wherein the first pivoting latch pivots about a first pivot point medial the actuator end and the container end; and wherein
the second pivoting latch pivots about a second pivot point medial the actuator end and the container end.
